(19) United States
(12) Patent Application Publication
(10) Pub. No.: US 2024/0240658 A1
(43) Pub. Date: Jul. 18, 2024

(54) HYDRAULIC POWER PACK MODULE

(71) Applicants: Narendra Gupta, Eindhoven (NL); Abhilash Jagadeesh, Arnhem (NL)

(72) Inventors: Narendra Gupta, Eindhoven (NL); Abhilash Jagadeesh, Arnhem (NL)

(21) Appl. No.: 18/097,569

(22) Filed: Jan. 17, 2023

(51) Int. Cl. F15B 21/14; B66F 9/22; F15B 13/02; F15B 15/18

(52) U.S. Cl. CPC F15B 21/14; B66F 9/22; F15B 13/027; F15B 15/18

(57) ABSTRACT

A hydraulic module is provided for a materials-handling vehicle. The hydraulic module can include a mounting frame configured to mechanically connect to a frame of the vehicle but isolate the vehicle frame from vibrations occurring in the power pack. The mounting frame supports the primary components of a hydraulic energy recovery system, including, for instance, a hydraulic tank, a hydraulic pump, and an electric motor. The hydraulic energy recovery system components can be secured to the mounting frame before the mounting frame is connected to the vehicle frame. Standardized integration components such as cables, tubes, and wiring can be used to connect the module to the electrical and hydraulic systems of the vehicle. A fluid level sensor and indicator can be provided to indicate the fluid level of the hydraulic tank. Check valves can be mounted to adapter blocks to ensure low delta pressure during operation.

### TECHNICAL FIELD

This disclosure relates generally to methods and mechanisms for providing hydraulic systems to materials-handling vehicles, such as lift trucks or reach trucks (stackers). More particularly, this disclosure relates to hydraulic energy recovery systems for materials-handling vehicles.

### BACKGROUND INFORMATION

A hydraulic system uses hydraulic fluid pushed by a pump to create fluid power that can transfer energy from an electric motor to an actuator to perform work. A hydraulic power pack (or unit) is a portable power delivery system that holds energy for a hydraulic system. Hydraulic power units are generally self-contained systems that include a motor, a fluid reservoir (tank), and a pump. The hydraulic power unit supplies the hydraulic pressure needed to drive motors, cylinders, and other complementary parts of a given hydraulic system. Hydraulic reservoir filters (or tank filters) keep hydraulic fluid clean by preventing contaminants from entering the hydraulic tanks.

Hydraulic energy recovery systems have been devised and implemented to recover potential energy from hydraulic systems, such as those used in lift trucks or reach trucks (stackers). In particular, stackers use hydraulic power to drive hydraulic actuators to lift loads. When a load is lowered, the potential energy from the pressurized fluid in the hydraulic actuator can be recovered to some extent using a hydraulic power recovery system. More particularly, in a hydraulic energy recovery system, as the load is lowered, hydraulic fluid is forced through a hydraulic motor that can, in turn, rotate an electric motor to act as a generator, converting potential energy into electric energy that can be stored in a battery.

Hydraulic energy recovery systems for materials-handling vehicles can include the hydraulic and electrical components necessary to perform the hydraulic energy recovery process. These components include, for example, one or more hydraulic pumps, an electrical motor(s), a hydraulic integrated circuit, energy recovery valve(s), suction and return blocks, check valves, and a hydraulic tank.

Conventional hydraulic energy recovery systems for materials-handling vehicles are designed and built specifically for a given vehicle based on that vehicle's hydraulic energy recovery needs and space requirements of that vehicle. These hydraulic components are installed directly into the vehicle frame at the factory as part of the overall vehicle manufacturing process. OVERVIEW OF DISCLOSURE

According to principles of the present inventive concepts, a modular hydraulic power pack for a materials-handling vehicle accommodates all the main hydraulic and electrical components provided for energy recovery into a single modular frame. In one embodiment, a hydraulic power pack module includes a mounting frame configured to be installed in a materials-handling vehicle. The primary hydraulic and electrical components for performing a materials-handling vehicle energy recovery process are arranged together within or along the modular frame as a modular sub-assembly for the vehicle before being integrated into the materials-handling vehicle. A modular design also isolates and protects the main frame of the materials-handling vehicle from vibrations that occur in the hydraulic power pack.

More specifically, hydraulic power pack components including, for example, a hydraulic pump, an electrical motor, a hydraulic integrated circuit, an energy recovery valve, suction and return blocks, check valves, and a hydraulic tank, can all be provided within a modular frame. The modular frame can be attached to the vehicle frame after it is pre-assembled with all of the hydraulic power pack components. The hydraulic power pack can also include standardized input/output connectors (integration components) for communicating with the other materials-handling vehicle components, including the vehicle's electrical and hydraulic systems.

Modular frames support improved manufacturability and reduced manufacturing costs. For example, using the inventive concepts, hydraulic systems for different types of materials-handling vehicles can be provided in a single preassembled configuration from a factory, thereby reducing parts counts and improving efficiency. Using modular frames also makes it simple to replace defective systems in existing vehicles as well as upgrade/downgrade to higher/different configurations within a manufacturing facility or by dealers. For instance, an entire modular frame could be easily removed from a truck and replaced with a new modular frame containing replacement, upgraded, or different components.

Moreover, use of the same integration parts like tubing, cables, wiring, etc., is facilitated and helps reduce costs by permitting higher parts volumes and fewer part numbers to maintain. The mechanical and electrical connections between the truck and the components contained in the modular frame can be made identical, or nearly identical, which can lead to use of fewer parts across different truck configurations.

According to one embodiment, a hydraulic module includes a single mounting frame configured to secure all of the major hydraulic and electrical components for a hydraulic energy recovery system of a materials-handling vehicle. The mounting frame contains connection points for securing the mounting frame to a frame of the materials-handling vehicle. The mounting frame further includes connection points for securing the module components to the frame. For instance, a hydraulic tank and pump can be secured to the mounting frame before the mounting frame is installed in the vehicle and connected to the vehicle frame. The modular mounting frame can further accommodate additional components of the hydraulic energy recovery system, including, for example, an electric motor, a hydraulic integrated circuit, energy recovery valves, suction and return blocks, and check valves.

The modular frame permits preassembly of the hydraulic system into a modular sub-assembly before inclusion in the materials-handling vehicle. The entire modular frame can be removed from the vehicle and replaced with a new modular frame for servicing or upgrades. The same integrated parts (like tubing, cables, wiring, etc.) can be used to connect the hydraulic energy recovery system module to the vehicle regardless of the specific components in the modular frame. The use of the same integrated parts helps to use fewer parts across different vehicle configurations.

Therefore, according to principles of the present inventive concepts, all of the main components of a hydraulic energy recovery system can be preassembled as a sub-assembly onto a modular frame before being connected to the truck frame. This simplifies the manufacturing process by permitting the entire system to be assembled outside the vehicle frame and then dropped into place. The modular assembly also provides for known connection points and eases the hose/pipe routing both within the modular assembly as well as to the vehicle's other electrical and hydraulic systems.

Due to its modular assembly, this design acts as an isolator that protects the main frame from vibrations that would otherwise be transferred to it from the hydraulic system. The modular design is also more accurate and simpler to manufacture. In addition, the center of gravity (COG) can be accurately determined for the modular assembly which is key parameter for the right selection of an isolator.

According to additional features of the present inventive concepts, check valves can be mounted to the suction port of the hydraulic pump to ensure that proper hydraulic fluid (e.g., oil) flow is sent back to the rod side of the cylinders during the energy recovery mode to avoid cavitation. In one embodiment, two 22″ SAE check valves can be mounted on the 3″ suction port of the hydraulic pump. One or more adaptor blocks are designed to mount the check valves within the modular frame in the proper position and orientation with respect to the suction port of the hydraulic pump to permit return flow of hydraulic fluid back to the cylinders and the tank. Because of space constraints, it may not be possible or desirable to mount the check valves on opposite faces of a single adaptor block. Accordingly, multiple adaptor blocks may be used to mount the check valves to ensure the low delta pressure and proper suction hose routing to the pump and tank.

In one embodiment, for example, the two check valves can be mounted on adjacent sides of a first adapter block. A second adapter block can be provided to connect the first adapter block to the suction port of the pump.

According to still further features of the present inventive concepts, a fluid (e.g., oil) level sensor may be provided to determine a hydraulic fluid level within the storage tank. Since the hydraulic tank is mounted within the modular frame, it may be difficult for an operator to check the hydraulic fluid level during a routine (e.g., daily) check. A fluid level indicator (e.g., gauge) may be provided in a position that is readily observable by an operator, such as in a vehicle cabin, along an outside of the vehicle, or on the hydraulic tank itself. The fluid level gauge may communicate with the fluid level sensor to determine and indicate to a user the level of hydraulic fluid in the storage tank.

Additional aspects and advantages will be apparent from the following detailed description of example embodiments, which proceeds with reference to the accompanying drawings.

### BRIEF DESCRIPTION OF THE DRAWINGS

The foregoing and additional objects, features, and advantages of the present inventive concepts will become more readily apparent from the following detailed description of preferred embodiments, depicted in the attached drawings, in which:

FIG. 1A is an isometric illustration of a frame for a reach truck having a complete hydraulic system, including a hydraulic module and wires and tubing incorporated therein according to an embodiment of the present inventive concepts.

FIG. 1B is an isometric illustration of a frame for a hydraulic module according to principles of the present inventive concepts.

FIG. 1C is an isometric illustration of the hydraulic module frame of FIG. 1B connected to the vehicle frame according to still further principles of the present inventive concepts.

FIG. 1D is an isometric illustration of a hydraulic module arranged within a vehicle frame.

FIG. 2 is an isometric illustration of the hydraulic module removed from the vehicle frame of FIG. 1A.

FIGS. 3A-3C provide various isometric and close-up views showing a connection between the modular frame of the hydraulic module of FIG. 2 and the vehicle frame of FIG. 1A.

FIG. 4 is a close-up isometric illustration of adaptor blocks for ensuring low delta pressure during all working scenarios of the hydraulic module of FIG. 2.

FIGS. 5A and 5B are a somewhat schematic isometric and close-up view, respectively, of a fluid level sensor and indicator providing an easy-access indication of a hydraulic fluid level in the hydraulic tank of the hydraulic module of FIG. 2.

### DETAILED DESCRIPTION OF EMBODIMENTS

Example embodiments are described below with reference to the accompanying drawings. Unless otherwise expressly stated, the sizes, positions, etc., of components, features, elements, etc., as well as any distances therebetween, are not necessarily to scale in the drawings, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete and will convey the scope of the disclosure to those skilled in the art.

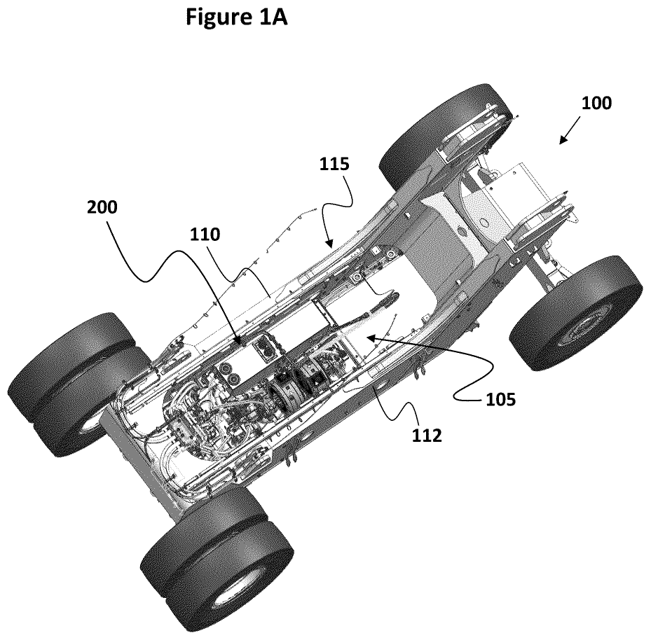

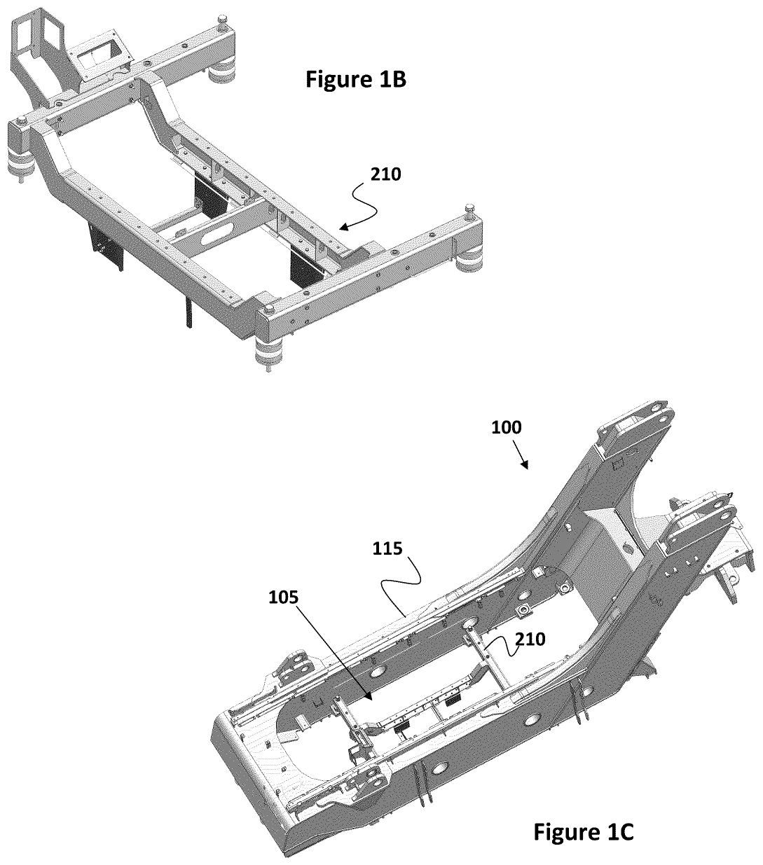

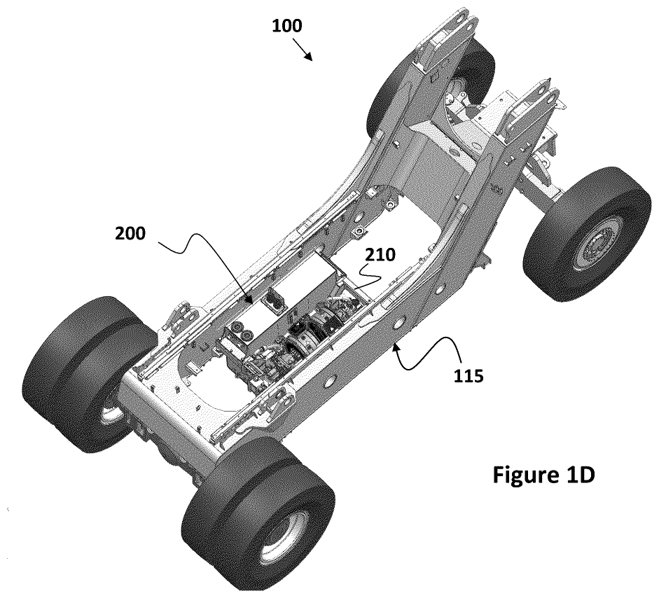

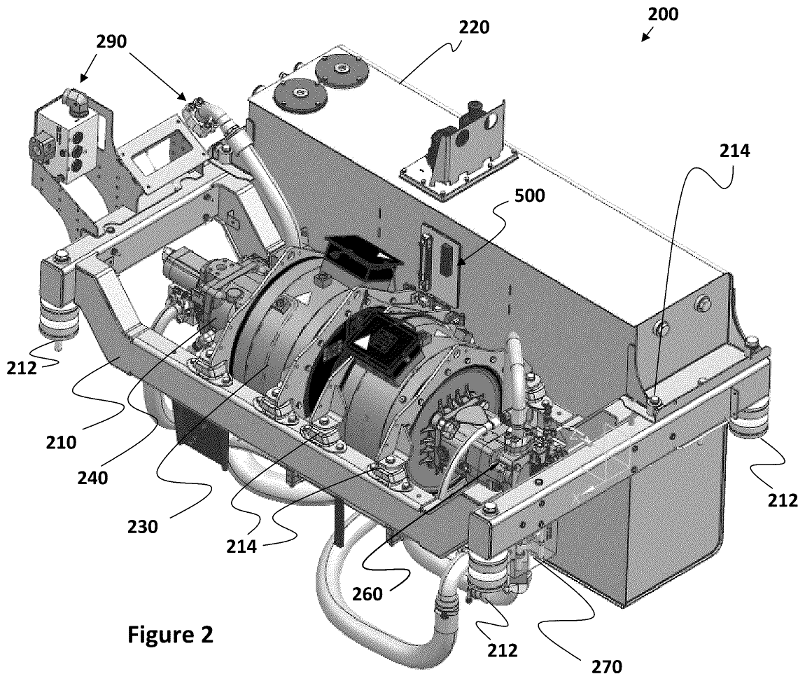

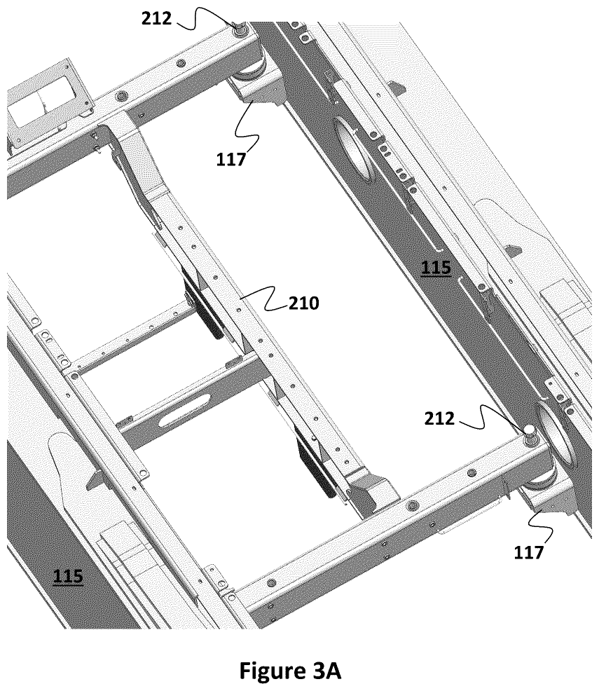

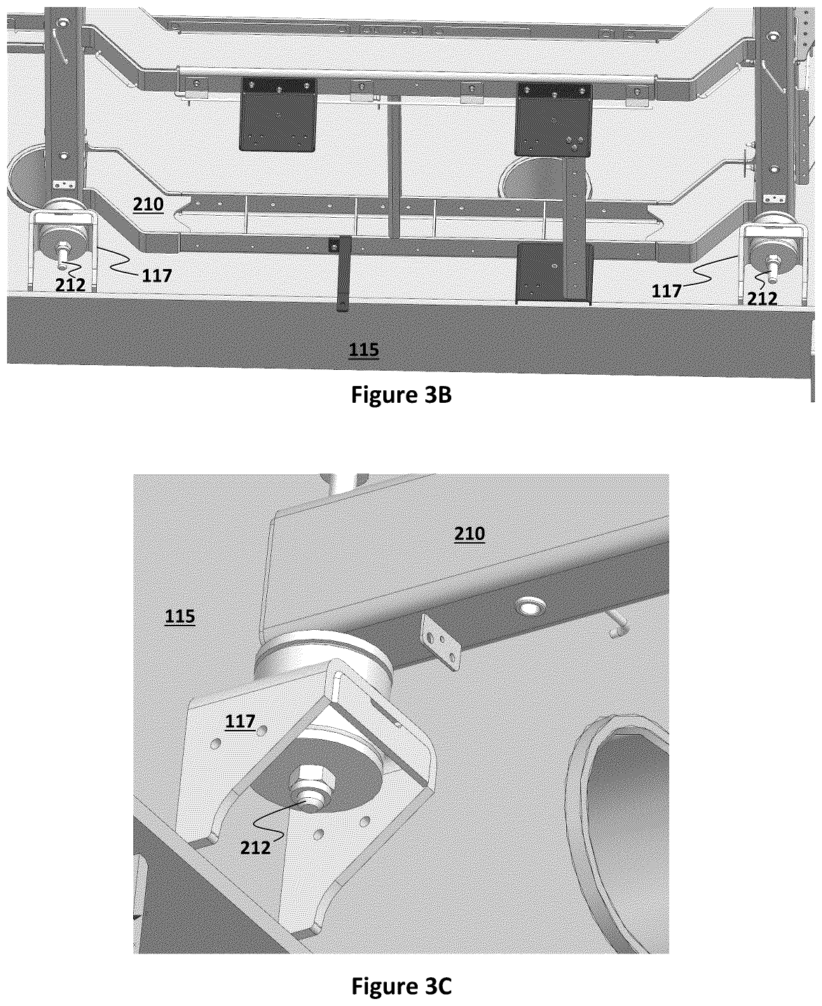

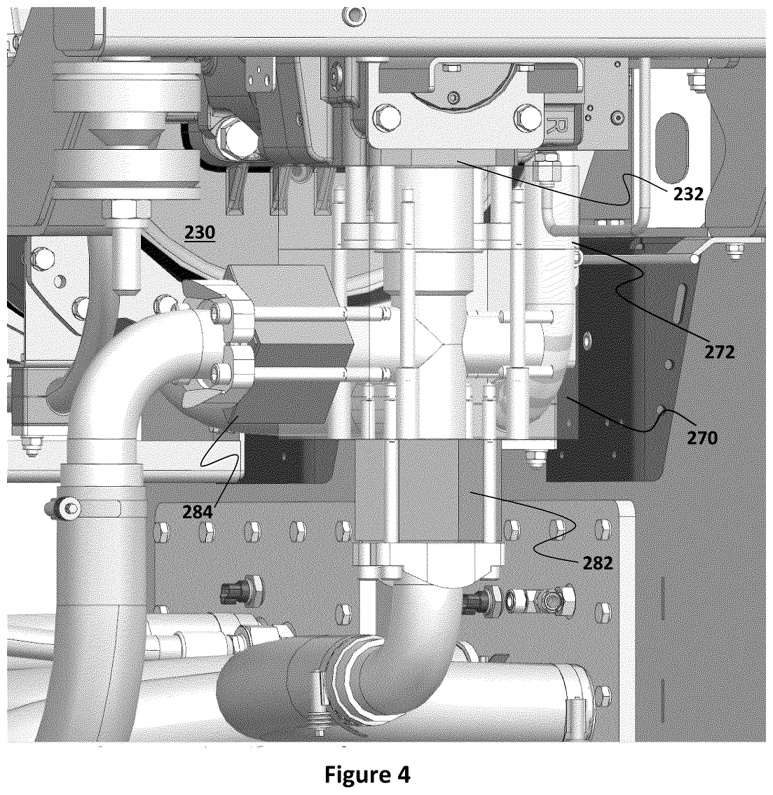

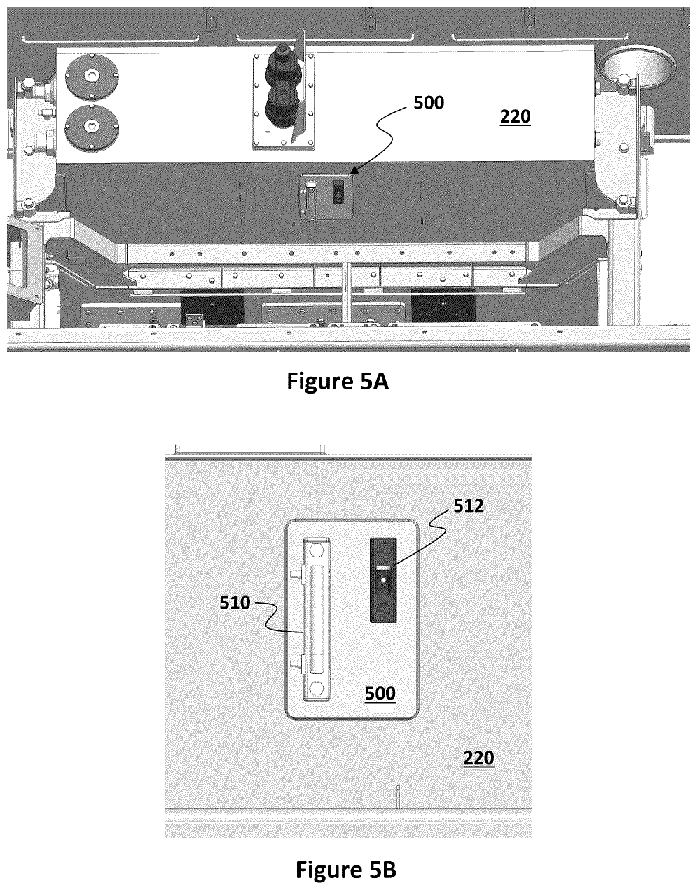

FIG. 1A is an isometric illustration of a frame 115 for a materials-handling vehicle (e.g., a reach truck) having a hydraulic module 200 incorporated therein according to an embodiment of the present inventive concepts. FIG. 2 is an isometric illustration of the hydraulic module 200 removed from the vehicle frame 115 of FIG. 1A. FIG. 3A is a close-up view showing a connection between the modular frame 210 of the hydraulic module 200 of FIG. 2 and the vehicle frame 115 of FIG. 1A. FIGS. 1A-1D illustrate the modular frame 210, the vehicle frame 115 and the hydraulic module in various degrees of assembly. FIG. 2 is an isometric illustration of the hydraulic module 200, while FIGS. 3A, 3B and 3C illustrate mechanisms for connecting the frame 210 of the hydraulic module 200 to the vehicle frame 115. FIG. 4 is a close-up view of the adapter blocks for the hydraulic system 200. And FIGS. 5A and 5B illustrate a hydraulic fluid level sensor and indicator for the hydraulic module 200.

Referring to FIGS. 1A-5B, a materials-handling vehicle 100 includes a frame 115. The vehicle frame 115 can, for instance include two longitudinally arranged frame members 110, 112 with a space 105 therebetween. An electric drive train (not shown) and other vehicle components can be arranged in the space 105 between the two longitudinally arranged frame members 110, 112.

According to principles of the present inventive concepts, a hydraulic power pack module 200 for a materials-handling vehicle 100, accommodates all the main hydraulic and electrical components provided for hydraulic energy recovery into a single modular frame 210. In one embodiment, the hydraulic power pack module 200 includes a mounting frame 210 configured to be installed in a materials-handling vehicle 100. The primary hydraulic and electrical components for performing a materials-handling vehicle energy recovery process can be arranged together within or along the modular frame 210 as a modular sub-assembly for the vehicle 100 before (or after) being integrated into the materials-handling vehicle 100.

More specifically, hydraulic power pack 200 components including, for example, a hydraulic tank 220, a hydraulic pump 230, an electrical motor 240, a hydraulic integrated circuit (not shown), an energy recovery valve 260, suction and return blocks 270, 272, respectively, and check valves 282, 284, can all be provided within or along a modular frame 210. The modular frame 210 of the hydraulic module 200 can be attached to the vehicle frame 115 using connection mechanisms (such as threaded bolts) 212 secured to connection brackets 117 that are welded or otherwise secured to the vehicle frame 115. The hydraulic module 200 can, for instance, be secured to the vehicle frame 115 after it is pre-assembled with all of the hydraulic power pack 200 components. The hydraulic power pack module 200 can also include standardized input/output connectors (integration components) 290 for communicating with the other materials-handling vehicle components, including the vehicle's electrical and hydraulic systems.

Modular frames support improved manufacturability and reduced manufacturing costs. For example, using the inventive concepts, hydraulic systems for different types of materials-handling vehicles can be provided in a single preassembled configuration from a factory, thereby reducing parts counts and improving efficiency. Using modular frames also makes it simple to replace defective systems in existing vehicles as well as upgrade/downgrade to higher/different configurations within a manufacturing facility or by dealers. For instance, an entire modular frame could be easily removed from a truck and replaced with a new modular frame containing replacement, upgraded, or different components.

Moreover, use of the same integration parts like tubing, cables, wiring, etc., is facilitated and helps reduce costs by permitting higher parts volumes and fewer part numbers to maintain. The mechanical and electrical connections between the truck and the components contained in the modular frame can be made identical, or nearly identical, which can lead to use of fewer parts across different truck configurations.

In the embodiment of FIGS. 1A-5B, a hydraulic module 200 includes a single mounting frame 210 configure to secure all of the major hydraulic and electrical components for a hydraulic energy recovery system of a materials-handling vehicle 100. The mounting frame 210 contains connection points 212 for securing the mounting frame 210 to a frame 115 of the materials-handling vehicle 100. The mounting frame 210 further includes connection points 214 for securing the module components 220, 230, etc. to the modular frame 210. For instance, a hydraulic tank 220 and pump 230 can be secured to the mounting frame 210 at connection points 214 before the mounting frame 210 is installed in the vehicle 100 and connected to the vehicle frame 115 at connection points 212. The modular mounting frame 210 can further accommodate additional components of the hydraulic energy recovery system, including, for example, an electric motor 240, a hydraulic integrated circuit 250, energy recovery valves 260, suction and return blocks 270, 272, respectively, and check valves 282, 284.

The modular frame 210 permits preassembly of the hydraulic system into a modular sub-assembly 200 before inclusion in the materials-handling vehicle 100. The entire modular sub-assembly 200 can be removed from the vehicle 100 and replaced with a new modular sub-assembly 200 for servicing or upgrades. The same integrated parts (like tubing, cables, wiring, etc.) 290 can be used to connect the hydraulic energy recovery system module 200 to the vehicle 100 regardless of the specific components in the modular sub-assembly 200. The use of the same integrated parts helps to use fewer parts across different vehicle configurations.

Therefore, according to principles of the present inventive concepts, all of the main components of a hydraulic energy recovery system can be preassembled as a sub-assembly onto a modular frame before being connected to the truck frame. This simplifies the manufacturing process by permitting the entire system to be assembled outside the vehicle frame and then dropped into place. The modular assembly also provides for known connection points and eases the hose/pipe routing both within the modular assembly as well as to the vehicle's other electrical and hydraulic systems.

The hydraulic module provides a closed-loop system that also acts as an isolator to isolate the hydraulic frame and ensure vibrations in the hydraulic frame do not adversely affect the main frame. Due to its modular assembly, this design is more accurate and simpler to manufacture. In addition, the center of gravity (COG) can be accurately determined for the modular assembly which is key parameter for the right selection of an isolator.

FIG. 4 is a close-up isometric illustration of adaptor blocks 270, 272 for ensuring low delta pressure during all working scenarios of the hydraulic module of FIG. 2. Referring specifically to FIG. 4, according to additional features of the present inventive concepts, check valves 282, 284 can be mounted to the suction port 232 of the hydraulic pump 230 to ensure that proper hydraulic fluid (e.g., oil) flow is sent back to the rod side of the cylinders during the energy recovery mode to avoid cavitation. In one embodiment, two 2½″ SAE check valves 282, 284 can be mounted on the 3″ suction port 232 of the hydraulic pump 230. One or more adaptor blocks 270, 272 are designed to mount the check valves 282, 284 within the modular frame 210 in the proper position and orientation with respect to the suction port 232 of the hydraulic pump 230 to permit return flow of hydraulic fluid back to the cylinders and the tank. Because of space constraints, it may not be possible or desirable to mount the check valves on opposite faces of a single adaptor block. Accordingly, multiple adaptor blocks may be used to mount the check valves to ensure the low delta pressure and proper suction hose routing to the pump and tank.

In one embodiment, for example, the two check valves 282, 284 can be mounted on adjacent sides of a first adapter block 270. A second adapter block 272 can be provided to connect the first adapter block 270 to the suction port 232 of the pump 230. The suction block can be just a junction block, while the return block preferably includes logic valves to ensure that part of the hydraulic fluid is circulated back to the rod side of the derrick cylinders to avoid cavitation.

FIGS. 5A and 5B are a somewhat schematic and close-up view, respectively, of a hydraulic fluid level indicator assembly 500 providing an easy-access indicator 510 of a fluid (e.g., oil) level in the hydraulic tank 220 of the hydraulic module 200 of FIG. 2. Referring specifically to FIGS. 5A and 5B, according to still further features of the present inventive concepts, a fluid (i.e., oil) level sensor 512 may be provided in communication with the hydraulic tank 220 to determine a hydraulic fluid level within the storage tank 220. Since the hydraulic tank 220 is mounted within the modular frame 210, it may be difficult for an operator or other personnel to check the hydraulic fluid level during a routine (e.g., daily) check. A fluid level indicator (e.g., gauge) 510 may be provided in a position that is readily observable by an operator, such as in a vehicle cabin, along an outside of the vehicle 100, or in a readily observable position on the outside of the hydraulic tank 220. The fluid level gauge 510 may communicate with the fluid level sensor to determine the level of hydraulic fluid in the storage tank 220 and visually indicate the level to a user.

### CONCLUSION

Various other improvements are also contemplated and numerous variations to the specific designs identified above are possible without departing from the spirit and scope of the inventive concepts. Having described and illustrated principles of the present inventive concepts in various preferred embodiments thereof, it should be apparent that the invention can be modified in arrangement and detail without departing from such principles.

The terms and descriptions used above are set forth by way of illustration and example only and are not meant as limitations. Those skilled in the art will recognize that many variations, enhancements, and modifications of the concepts described herein are possible without departing from the underlying principles of the invention. For example, skilled persons will appreciate that the subject matter of any sentence or paragraph can be combined with subject matter of some or all of the other sentences or paragraphs, except where such combinations are mutually exclusive. The scope of the invention should therefore be determined only by the following claims, claims presented in continuation applications, claims presented in post-grant proceedings (e.g., reissue, reexamination, inter partes review, or post-grant review), and equivalents to the foregoing claims.

1. A hydraulic energy recovery module for a lift truck, said module comprising:
a mounting frame configured to attach to a frame of the lift truck and further configured to receive and support components of the hydraulic energy recovery module;
a hydraulic tank mounted to the mounting frame;
a hydraulic pump mounted to the mounting frame; and
an electric motor mounted to the mounting frame.

2. A hydraulic energy recovery module according to claim 1, wherein the mounting frame comprises connection points for mechanically connecting the mounting frame to the frame of the lift truck.

3. A hydraulic energy recovery module according to claim 1, wherein the mounting frame comprises connection points for physically securing the hydraulic tank, hydraulic pump, and electric motor to the mounting frame.

4. A hydraulic energy recovery module according to claim 1, further comprising:
a hydraulic integrated circuit,
an energy recovery valve,
a suction block,
a return block, and
one or more check valves.

5. A hydraulic energy recovery module according to claim 1, further comprising a fluid level sensor configured to determine a level of hydraulic fluid within the hydraulic tank.

6. A hydraulic energy recovery module according to claim 5, further comprising a fluid level indicator operatively coupled to the fluid level sensor and arranged in a position that is readily observable by a user, said fluid level indicator indicating the level of hydraulic fluid within the hydraulic tank.

7. A hydraulic energy recovery module according to claim 1, further comprising one or more adapter blocks connected to a suction port of the pump, said adapter blocks configured to mount check valves in communication with the suction port to enable the return of hydraulic fluid back to the pump and to ensure low delta pressure during operation.

8. A hydraulic energy recovery module according to claim 7, wherein the one or more adapter blocks comprise two adapter blocks, wherein a first adapter block is configured to arrange two check valves on adjacent sides of the adapter block and wherein a second adapter block is configured to connect the first adapter block to the pump.

9. A hydraulic energy recovery module according to claim 1, wherein the hydraulic energy recover module is pre-assembled with the hydraulic energy recovery module components before securing to the lift truck.

10. A hydraulic energy recovery module according to claim 1, further comprising standardized interfaces for communicating between the hydraulic energy recovery module and hydraulic and electrical systems of the lift truck.

11. A method providing a lift truck with a hydraulic energy recovery system, the method comprising:
mounting a plurality of hydraulic energy recovery components to a single mounting frame, said plurality of hydraulic energy recovery components comprising at least two or more components selected from the group comprising: a hydraulic tank, a hydraulic pump, an electric motor, and a hydraulic integrated circuit; and
connecting the single mounting frame to a frame of the lift truck after mounting the plurality of hydraulic energy recovery components to the single mounting frame.

12. A method according to claim 11, wherein the plurality of hydraulic energy recovery components comprises a hydraulic tank, a hydraulic pump, and an electric motor.

13. A method according to claim 12, wherein the plurality of hydraulic energy recovery components further comprises a hydraulic integrated circuit, an energy recovery valve, a suction block, a return block, and one or more check valves.

14. A method according to claim 11, wherein mounting the plurality of hydraulic energy recovery components to the single mounting frame comprises physically connecting the hydraulic energy recovery components directly to the single mounting frame or to another one of the hydraulic energy recovery components that is mounted to the single mounting frame.

15. A method according to claim 14, wherein the single mounting frame comprises connection points for connecting at least the hydraulic tank and the hydraulic pump directly to the mounting frame.

16. A method according to claim 11, further comprising:
providing one or more integration members for connecting hydraulic and electrical components of the lift truck to the hydraulic energy recovery components mounted to the mounting frame.

17. A reach truck comprising:
a frame configured to support internal components of the lift truck;
a mounting frame supporting a plurality of components of a hydraulic energy recovery system, said mounting frame mechanically connected to the reach truck frame; and
wherein the plurality of components of the hydraulic energy recovery system includes a hydraulic pump, an electric motor, and a hydraulic tank.

18. A reach truck according to claim 17, further comprising:
a hydraulic fluid level sensor configured to sense a level of fluid in the hydraulic tank; and
a fluid level indicator arranged on the reach truck and configured to provide an observable indication of the fluid level in the hydraulic tank.

19. A reach truck according to claim 17, wherein the plurality of components further comprises a hydraulic integrated circuit, an energy recovery valve, a suction block, a return block, and one or more check valves.

20. A reach truck according to claim 19, wherein the check valves are connected to the suction block.
